(19) United States
(12) Patent Application Publication
(10) Pub. No.: US 2009/0008998 A1
(43) Pub. Date: Jan. 8, 2009

(54) Electrical Power Distribution and Control System

(75) Inventors: Grant Behrentdorff, Northern Territory (AU); Lyndon Frearson, Northern Territory (AU); Dennis Stanley, Northern Territory (AU); Clayton Franklin, Northern Territory (AU)

Correspondence Address: AKERMAN SENTERFITT, P.O. BOX 3188, WEST PALM BEACH, FL, 33402-3188, US

(73) Assignee: Centre for Appropriate Technology Inc., Aleice Springs, Northern Terriotory (AU)

(21) Appl. No.: 11/997,686

(22) PCT Filed: Aug. 3, 2006
(86) PCT No.: PCT/AU2006/001090

§ 371 Date: Jul. 14, 2008

(30) Foreign Application Priority Data
Aug. 3, 2005 (AU) 2005904188

(51) Int. Cl. H02J 4/00

(52) U.S. Cl. 307/35

(57) ABSTRACT

The invention relates to an electrical power distribution and control system adapted to accept electrical power from one or more electrical power supply sources and meter and monitor consumption of this power by a user. The system can be programmed with a time period and an electrical power allowance for both critical and non critical loads for this period of time, and it can shut-off power supply to non-critical loads if the allowance for these has been exceeded before the time period has elapsed.

### TECHNICAL FIELD

The present invention relates to an electrical power distribution and control system.

For the purposes of explanation, reference will be made to use of the present invention in small, remote communities with finite electrical power supplies. It would be understood by those of ordinary skill in the art however that the invention is not necessarily limited to use in remote communities, its application could extend to use in urban regions supplied with mains power.

### BACKGROUND ART

The provision of electrical power to remote communities, particularly small ones, is problematic. The provision of electrical power over long distances and vast areas is difficult to implement and expensive, consequently the mains power supply is often unavailable to these remote communities, and so many have their own power generation systems. These power generation systems may be any one of, or as is more often the case, a combination of fuel burning generators and renewable energy sources, such as solar energy or wind driven power generators.

Better communications, roads, television and radio have driven these remote communities to demand the same appliances as their urban counterparts. The resultant increase in electrical power demand in remote communities has placed a great deal of importance on the ability of remote communities to manage electricity usage, especially where power supply is shared and finite. It is an object of the present invention then to provide an electrical power distribution control system that can meter, monitor and control the electrical power consumption of users.

Other objects and advantages of the present invention will become apparent from the following description, taken in connection with the accompanying drawings, wherein, by way of illustration and example, an embodiment of the present invention is disclosed.

For the purpose of this specification the word “comprising” means “including but not limited to”, and the word ‘comprises’ has a corresponding meaning.

### DISCLOSURE OF THE INVENTION

In one form of this invention although this may not necessarily be the only or indeed the broadest form of this there is proposed an electrical power distribution and control system adapted to accept electrical power from one or more supply sources and meter and monitor consumption of this power by a user, wherein the system can be programmed with a time period and an electrical power allowance for both critical and non critical loads for this period of time, and it can shut-off power supply to non-critical loads if the allowance for these has been exceeded before the time period has elapsed.

Preferably, the system includes a visual indication means for indicating how much of the power allowance for non-critical loads has been used.

Preferably, the system includes a main switchboard and a user interface.

Preferably, the main switchboard replaces the standard consumer switchboard.

Preferably, the user interface incorporates the visual indication means.

Preferably, the power supply source is one or more of a renewable energy supply, a fuel driven generator, or a town supply.

Preferably, the time period is 24 hours.

Preferably, the power allowance is reset at the end of the time period.

Preferably, the renewable energy supply is an array of solar modules charging a battery or batteries.

Preferably, the system incorporates programmable means, which can be programmed with power allowances and the time period.

In a further form, the invention may be said to lie in an electrical power distribution and control system adapted to accept electrical power from one or more supply sources and meter and monitor consumption of this power by a user, wherein the system can be programmed with a time period and an electrical power allowance for this period of time, and it can shut-off power supply if the allowance has been exceeded before the time period has elapsed.

In a further form, the invention may be said to lie in a method of monitoring and controlling the distribution of electrical power including the steps of, assigning a power allowance for non-critical loads, assigning a power allowance for the combined critical and non-critical loads, assigning a time period, measuring elapsed time and power used, disconnecting power supply to non-critical loads if the allowance for these has been exceeded before the time period has elapsed.

Preferably, the method includes the further step of resetting the allowances once the time period has elapsed.

Preferably, the method includes the further step of indicating the amount of the non-critical allowance remaining at any given time.

### BRIEF DESCRIPTION OF THE DRAWINGS

For a better understanding of this invention it will now be described with respect to the preferred embodiment which shall be described herein with the assistance of drawings wherein;

FIG. 1 is a schematic illustration of a remote community and its power supply sources; and

FIG. 2 is a schematic illustration of the user interface.

### DETAILED DESCRIPTION OF THE INVENTION

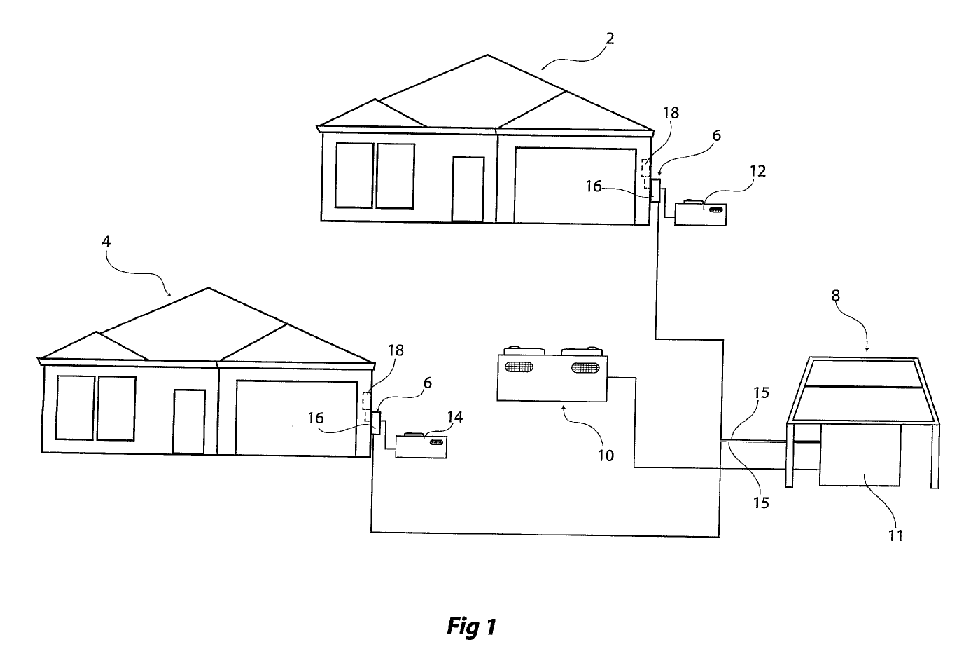

Referring now to the illustrations, and in particular to FIG. 1, where there is shown a small, remote community consisting of two buildings 2 and 4 in this case, each having an electrical power distribution and control system 6 accepting electrical power from a power supply system comprising an array of solar modules 8, and a communal fuel driven generator 10. In addition to this, each building has its own individual, household fuel driven generator, 12 in one case, and 14 in the other.

Each electrical power distribution and control system 6 includes a main switchboard 16 and user interface 18, which are housed in separate enclosures.

The main switchboard 16 replaces the buildings existing switchboard, it is then electrically connected to the user interface box 18, which is located away from the switchboard 16 in a convenient location in the house, where the occupants can easily inspect it.

Power from the communal power sources, namely the array of solar modules 8 and the generator 10, is transmitted to a junction box 11. The junction box encloses the inverter for the solar modules, the batteries for storing the power generated by these, circuit breakers, and a switch that allows a user to manually select between power sources if required (the system can do this automatically). From the junction box, power is transmitted to the switchboard 16 by electrical cables 15, as per standard practice.

In addition to this, the household generators 12 and 14 can be connected to the respective switchboards 16 via an inlet socket in the side of the switchboard enclosure.

The main switchboard incorporates circuit breakers, an electricity meter and a programmable micro controller.

This programmable micro controller controls power supply to the household circuits supplying both the critical and non-critical appliances, and sends signals to the user interface box 18 so that it can indicate allowance status.

Critical appliances are those that are hard wired, such as basic lighting and the refrigerator. Non-critical appliances will include items such as fans, and most plug in items.

The programmable controller is programmed to provide a power allowance, and a period of time over which this allowance can be used. The critical allowance is a portion of the total allowance that is to be left in reserve specifically for the purpose of powering critical appliances once the remainder of the power allowance has been used.

For instance, the power allowance can be programmed on site with a range of 0.1 to 100 kWh per 24 hours, with the time period to be reset at either midnight or midday for instance. The programmable controller can then be locked using a password, so as to prevent alteration of the program values by residents.

The programmer can vary the power allowances for different times of the year or population fluctuations, depending upon the supply capacity of the renewable power source and power demands.

The programmable controller can also log data relating to numerous system parameters over a given period of time, thereby providing valuable information to the systems designers and maintainers relating to, amongst other things, energy demand and usage.

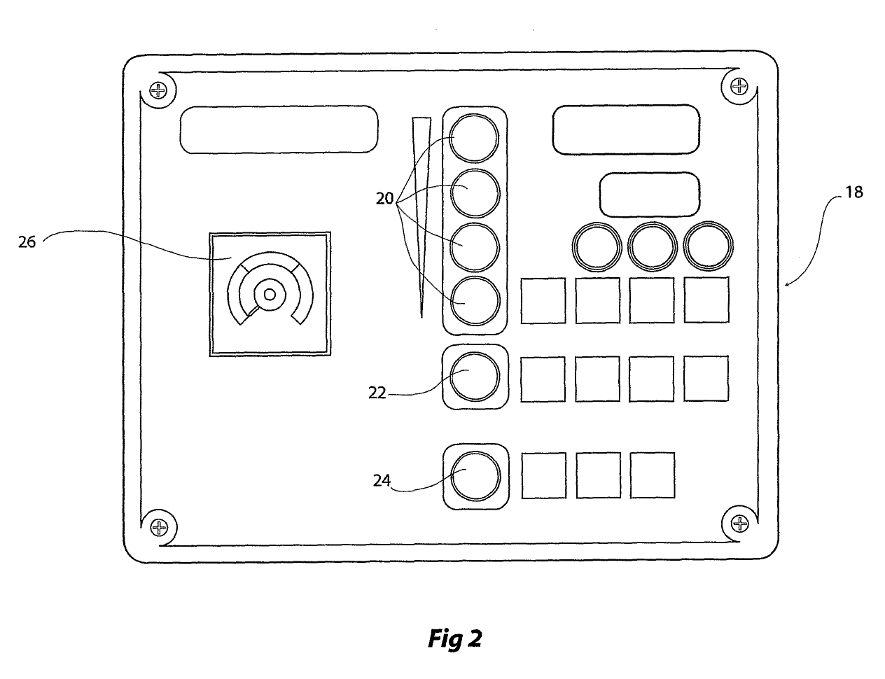

Referring now to FIG. 2, the user interface 18 has a series of coloured lights incorporated into its face, four green lights 20, one yellow light 22 and one blue light 24. Illumination of the green lights 20 indicates the portion of the allowance for non-critical appliances that remains. Illumination of the yellow light 22 indicates the availability of power for critical appliances, and illumination of the blue light 24 indicates the availability of power from generators.

The user interface also incorporates a gauge 26 that indicates the rate of power usage.

As non-critical appliances are used, the available power for these appliances is indicated by the number of illuminated green lights 20. Each of the four green lights 20 indicates 25% of the available power. When only 10% of the power allowance remains, the last illuminated green light will begin to flash. If the power allowance for non-critical items is used before the time period has elapsed, the last green light will go out and the power to non-critical appliances will be disconnected. Supply to these non-critical appliances is reconnected at the commencement of the next time period.

In the event that power to non-critical loads is disconnected, power supply to critical appliances is not affected unless the critical power allowance is exceeded or the rate of power consumption is beyond permissible limits. One of the fuel driven generators 10, 12 or 14 can be used to supplement the allowance, or to provide additional power for appliances that require a lot of power. If the communal generator 10 is running, the junction box 11 sends a signal to the switchboard 16, and it will suspend metering of the allowance, and provide unlimited power to all circuits. If one of the household generators 12 or 14 is running, that household's switchboard will detect this, and it will suspend metering of the allowance, and provide unlimited power to all circuits.

If the communal generator 10 is required but has broken down i.e. it fails to start, the junction box 11 sends a signal to the switchboard 16, and it then suspends supply to non-critical appliances, extinguishing the four non-critical indication lights 20 on the user interface box 18.

If there are long periods of cloud cover that cause to deplete the power stored by the batteries, the junction box 11 sends a signal to the switchboard 16 at the time of resetting, which then reduces the non-critical power allowance to 75% of the maximum, and indicates this by illuminating 3 of the 4 non-critical indication lights 20 on the user interface box 18.

These signals from the junction box 11 to the switchboard 16 can be transmitted via wires or a radio signal.

The system also provides central timing of up to three circuits to enable control of fan, power or lighting circuits etc from the user interface, this helps residents to manage their energy use and reduce energy consumption. It is considered that the electrical power distribution control system according to the present invention will be of particular use to those people living in remote communities, who share a finite power supply with others. A system such as this will prevent the occupants of one house for instance from using more that their allotted share of a limited electrical power supply.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1. An electrical power distribution and control system adapted to accept electrical power from one or more electrical power supply sources and meter and monitor consumption of this power by a user, wherein the system is programmed with a time period and an electrical power allowance for both critical and non critical loads for this period of time, and it is adapted to shut-off power supply to non-critical loads if the allowance for these has been exceeded before the time period has elapsed.

2. The electrical power distribution and control system of claim 1, wherein the system includes a visual indication means for indicating how much of the power allowance for non-critical loads has been used.

3. The electrical power distribution and control system as in claim 1, wherein the system includes a main switchboard and a user interface.

4. The electrical power distribution and control system as in claim 3, wherein the main switchboard replaces the standard consumer switchboard.

5. The electrical power distribution and control system as in claim 3, wherein the user interface incorporates the visual indication means.

6. The electrical power distribution and control system as in claim 5, wherein the visual indication means comprises four green lights, one yellow light and one blue light, wherein illumination of the green lights indicates the portion of the allowance for non-critical appliances that remains, illumination of the yellow light indicates the availability of power for critical appliances, and illumination of the blue light indicates the availability of power from generators.

7. The electrical power distribution and control system as in claim 1, wherein the electrical power supply source is one or more of a renewable energy supply, a fuel driven generator, or a town supply.

8. The electrical power distribution and control system as in claim 7, wherein the renewable energy supply is an array of solar modules charging a battery or batteries.

9. The electrical power distribution and control system as in claim 1, wherein the time period is 24 hours.

10. The electrical power distribution and control system as in claim 1, wherein the power allowance is reset at the end of the time period.

11. The electrical power distribution and control system as in claim 1, wherein the system incorporates programmable means, which can be programmed with power allowances and the time period.

12. The electrical power distribution and control system as in claim 11, wherein the programmable means is adapted to log data relating to system parameters.

13. The electrical power distribution and control system as in claim 1, wherein the system incorporates means for indicating the instantaneous rate of power usage.

14. An electrical power distribution and control system adapted to accept electrical power from one or more supply sources and meter and monitor consumption of this power by a user, wherein the system can be programmed with a time period and an electrical power allowance for this period of time, and it can shut-off power supply if the allowance has been exceeded before the time period has elapsed.

15. A method of monitoring and controlling the distribution of electrical power including the steps of, assigning a power allowance for non-critical loads, assigning a power allowance for the combined critical and non-critical loads, assigning a time period, measuring elapsed time and power used, disconnecting power supply to non-critical loads if the allowance for these has been exceeded before the time period has elapsed.

16. The method as in claim 15, wherein the method includes the further step of resetting the allowances once the time period has elapsed.

17. The method as in claim 15, wherein the method includes the further step of indicating the amount of the non-critical allowance remaining at any given time.
